(19) United States
(12) Patent Application Publication
(10) Pub. No.: US 2025/0289512 A1
(43) Pub. Date: Sep. 18, 2025

(54) TRUCK BED EXTENDERS INTEGRATED WITH BED TIE DOWN RAILS

(71) Applicant: Toyota Motor Engineering & Manufacturing North America, Inc., Plano, TX (US)

(72) Inventor: Braden M. Klish, Farmington Hills, MI (US)

(73) Assignees: Toyota Motor Engineering & Manufacturing North America, Inc., Plano, TX (US); Toyota Jidosha Kabushiki Kaisha, Toyota-shi, Aichi-ken (JP)

(21) Appl. No.: 18/604,048

(22) Filed: Mar. 13, 2024

(51) Int. Cl. B62D 33/08; B62D 33/027

(52) U.S. Cl. CPC B62D 33/08; B62D 33/0273

(57) ABSTRACT

A truck includes a truck bed located rearward of a passenger cabin in a vehicle longitudinal direction. The truck bed includes a bed deck, a first sidewall and a second sidewall. A truck bed extender includes a divider wall that extends in a vehicle lateral direction and side extenders on opposite sides of the divider wall that are configured to slidably connect to tie down rails within the truck bed. The side extenders are pivotally connected to the divider wall so that the side extenders pivot against the divider wall in a stowed configuration.

### TECHNICAL FIELD

The present specification generally relates to trucks and, more specifically, to trucks with truck beds including truck bed extenders.

### BACKGROUND

Vehicles often have storage areas where cargo is stowed. An example is a pickup truck with a truck bed. The truck bed provides a volume for storing cargo. Some cargo may have a tendency to move within the volume, particularly when the tuck moves. It may be desirable to increase or limit the amount of space of the truck bed depending on the cargo. Truck bed extenders are known that attach to end posts of the truck bed for extending an area of the truck bed while limiting movement of cargo. The truck bed extenders may be difficult to position and stow. What is needed are other truck bed extenders that are more readily repositionable.

### SUMMARY

In accordance with one embodiment, a truck includes a truck bed located rearward of a passenger cabin in a vehicle longitudinal direction. The truck bed includes a bed deck, a first sidewall and a second sidewall. A truck bed extender includes a divider wall that extends in a vehicle lateral direction and side extenders on opposite sides of the divider wall that are configured to slidably connect to tie down rails within the truck bed. The side extenders are pivotally connected to the divider wall so that the side extenders pivot against the divider wall in a stowed configuration.

In accordance with another embodiment, a truck bed extender for use in a bed of a truck includes a divider wall that extends in a vehicle lateral direction and side extenders on opposite sides of the divider wall that are configured to slidably connect to tie down rails within a truck bed of the truck. The side extenders are pivotally connected to the divider wall so that the side extenders pivot against the divider wall in a stowed configuration.

In accordance with another embodiment, a method of stowing a truck bed extender within a truck bed of a truck is provided. The method includes detaching a connector of the truck bed extender from a tie down rail that extends along a sidewall of the truck bed. The truck bed extender includes a divider wall that extends in a vehicle lateral direction and side extenders on opposite sides of the divider wall that are configured to slidably connect to tie down rails within the truck bed. The side extenders are pivotally connected to the divider wall so that the side extenders pivot against the divider wall in a stowed configuration. The truck bed extender is rotated such that the divider wall is adjacent a front wall of the truck bed. The side extenders are rotated relative to the divider wall such that the side extenders extend alongside the divider wall.

These and additional features provided by the embodiments described herein will be more fully understood in view of the following detailed description, in conjunction with the drawings.

### BRIEF DESCRIPTION OF THE DRAWINGS

The embodiments set forth in the drawings are illustrative and exemplary in nature and not intended to limit the subject matter defined by the claims. The following description of the illustrative embodiments can be understood when read in conjunction with the following drawings, where like structure is indicated with like reference numerals and in which:

FIG. 1 diagrammatically depicts a perspective rear view of a pickup truck including a truck bed with a truck bed extender, according to one or more embodiments shown and described herein;

FIG. 2 diagrammatically depicts a perspective view of the truck bed extender of FIG. 1 in isolation;

FIG. 3 diagrammatically illustrates a side view of a connector of the truck bed extender of FIG. 2 connected to a tie down rail, according to one or more embodiments shown and described herein;

FIG. 4 diagrammatically illustrates the truck bed extender of FIG. 1 in a rearward divider configuration with a divider wall over a deck of the truck bed, according to one or more embodiments shown and described herein;

FIG. 5 diagrammatically illustrates the truck bed extender of FIG. 1 in a forward divider configuration nearer to a front wall of the truck bed, according to one or more embodiments shown and described herein;

FIG. 6 diagrammatically illustrates the truck bed extender of FIG. 1 in a stowed configuration, according to one or more embodiments shown and described herein; and

FIG. 7 illustrates a method of stowing the truck bed extender of FIG. 1, according to one or more embodiments shown and described herein.

### DETAILED DESCRIPTION

Trucks according to the present specification include a passenger cabin and a truck bed located rearward of the passenger cabin in a vehicle longitudinal direction. The truck bed includes a bed deck, a first sidewall and a second sidewall. A truck bed extender includes a divider wall that extends in a vehicle transverse direction and side extenders on opposite sides of the divider wall that are configured to slidably connect to tie down rails that extend along the first and second sidewalls within a truck bed. The side extenders are pivotally connected to the divider wall so that the side extenders pivot against the divider wall in a stowed configuration. The position of the divider wall in the truck bed can be adjusted by sliding the side extenders longitudinally along the tie down rails forward and backward. The truck bed extender may also be turned so that the divider wall is adjacent a front wall of the truck bed.

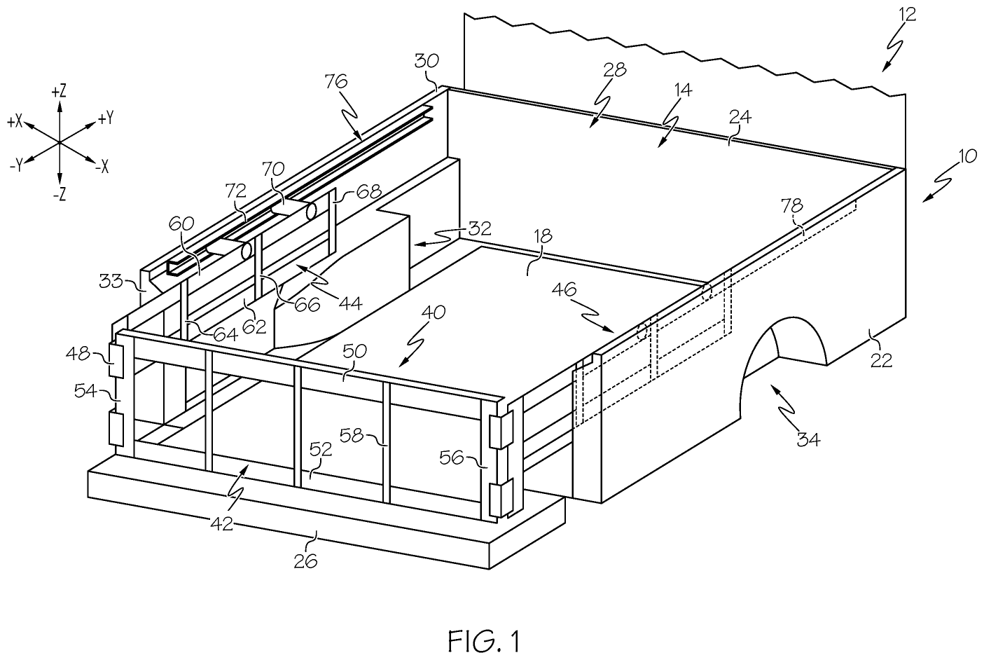

As used herein, the term “vehicle longitudinal direction” refers to the forward-rearward direction of the pickup truck (i.e., in the +/−vehicle Y direction depicted in FIG. 1). The term “vehicle lateral direction” refers to the cross-pickup truck direction (i.e., in the +/−vehicle X direction depicted in FIG. 1), and is transverse to the vehicle longitudinal direction. The term “vehicle vertical direction” refers to the upward-downward direction of the pickup truck (i.e., in the +/−vehicle Z-direction depicted in FIG. 1). As used herein, “upper” and “above” are defined as the positive Z direction of the coordinate axis shown in the drawings. “Lower” and “below” are defined as the negative Z direction of the coordinate axis shown in the drawings.

Referring to FIG. 1, the terms “outboard” or “outward” as used herein refers to the relative location of a component in a direction with respect to a pickup truck centerline. The term “inboard” or “inward” as used herein refers to the relative location of a component in a direction with respect to the pickup truck centerline. Because the pickup truck structures may be generally symmetrical about the pickup truck centerline, the direction to which use of terms “inboard,” “inward,” “outboard” and “outward” refer may be mirrored about the pickup truck centerline when evaluating components positioned along opposite sides of the pickup truck 10.

A pickup truck is generally illustrated at 10 with a passenger cabin 12 and a truck bed 14. The truck bed 14 includes a bed deck 18, a pair of spaced apart sidewalls 20, 22, a front wall 24, and a tailgate 26. The bed deck 18, the sidewalls 20, 22, the front wall 24, and the tailgate 26 define a storage area 28 of the truck bed 14.

The sidewalls 20, 22 extend parallel to the vehicle longitudinal direction. Each sidewall 20, 22 includes a front end 30 and an opposite rear end 33. The front wall 24 extends between the front ends 30 of the sidewalls 20, 22. The tailgate 26 extends between the rear ends 33 of the sidewalls 20, 22.

The tailgate 26 is pivotally connected to the sidewalls 20, 22 for movement between a closed position and an open position. In the closed position, the tailgate 26 extends parallel to the vehicle vertical direction. In the closed position, the tailgate 26 extends parallel to the vehicle vertical direction. In the open position, the tailgate 26 extends parallel to the vehicle longitudinal direction.

Wheel wells 32 and 34 are located in the storage area 28 of the truck bed 14. The wheel wells 32 and 34 are the enclosures that house the rear wheels of the truck 10. As can be seen, the wheel wells 32 and 34 extend inward from the sidewalls 20 and 22 and also vertically from the bed deck 18. In this regard, the wheel wells 32 and 34 take up space within the storage area 28. The wheel wells 32 also change the footprint of the bed deck 18 by reducing a width of the bed deck 18 between the wheel wells 32 and 34.

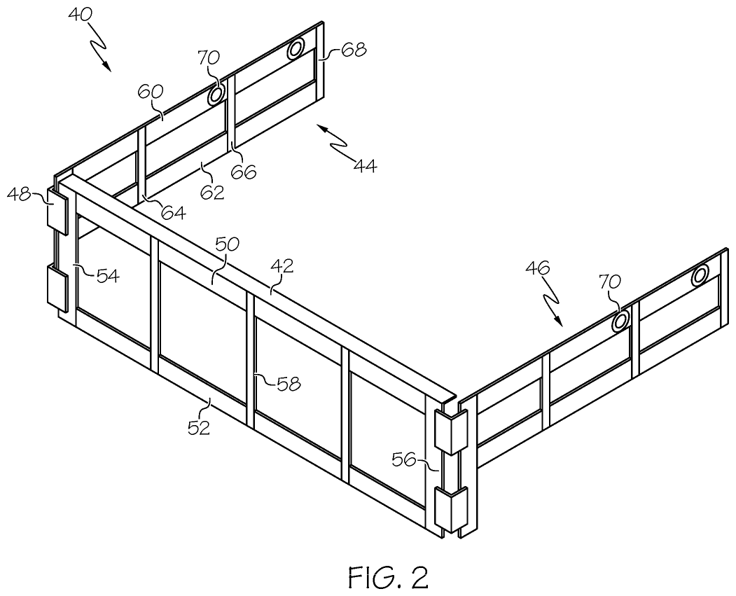

A truck bed extender 40 includes a divider wall 42 that extends in the vehicle lateral direction and side extenders 44 and 46 on opposite sides of the divider wall 42. Referring also to FIG. 2, the side extenders 44 and 46 are pivotally connected to the divider wall 42 using hinges 48 that provide pivot axes for the side extenders 44 and 46 relative to the divider wall 42. As can be seen, in this embodiment, the divider wall 42 is formed of lateral beams 50 and 52 that extend between vertical beams 54 and 56. Additional vertical beams 58 may be provided between the vertical beams 54 and 56 to provide added barrier material to the divider wall 42. While beams 50, 52, 54, 56 and 58 are illustrated, other possible configurations may include a panel, mesh or any other suitable configuration. For example, a MOLLE-type panel may be used, which is a load-carrying panel for attaching cargo thereto.

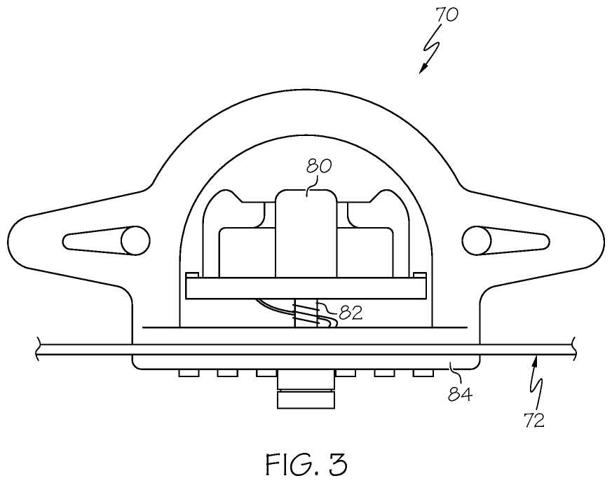

The side extenders 44 and 46 each include longitudinal beams 60 and 62 and vertical beams 64, 66 and 68 that extend between the longitudinal beams 60 and 62. The longitudinal beams 60 include connectors 70 that are configured to be received within slots 72 and 74 formed within tie down rails 76 and 78. Referring briefly to FIG. 3, the connectors 70 may be anchor clamps that are configured to slidably connect to the tie down rails 76 and 78 that extend along the sidewalls 20 and 22 within the truck bed 14. For example, the connectors 70 may include an anchor knob 80 connected to a threaded fastener 82 that can be turned to tighten and loosen an anchor body 84 that is shaped to be retained with the slots 72 and 74 (FIG. 1), which may be T-shaped to retain the anchor body 84.

The side extenders 44 and 46 are pivotally connected to the divider wall 42 so that the side extenders 44 and 46 pivot against the divider wall 42 in a stowed configuration. The position of the divider wall 42 in the truck bed 14 can be adjusted by sliding the side extenders 44 and 46 longitudinally along the tie down rails 76 and 78 forward and backward. The truck bed extender 40 may also be turned 180 degrees so that the divider wall 42 is adjacent the front wall 24 of the truck bed 14 in the stowed configuration, which will be described in greater detail below.

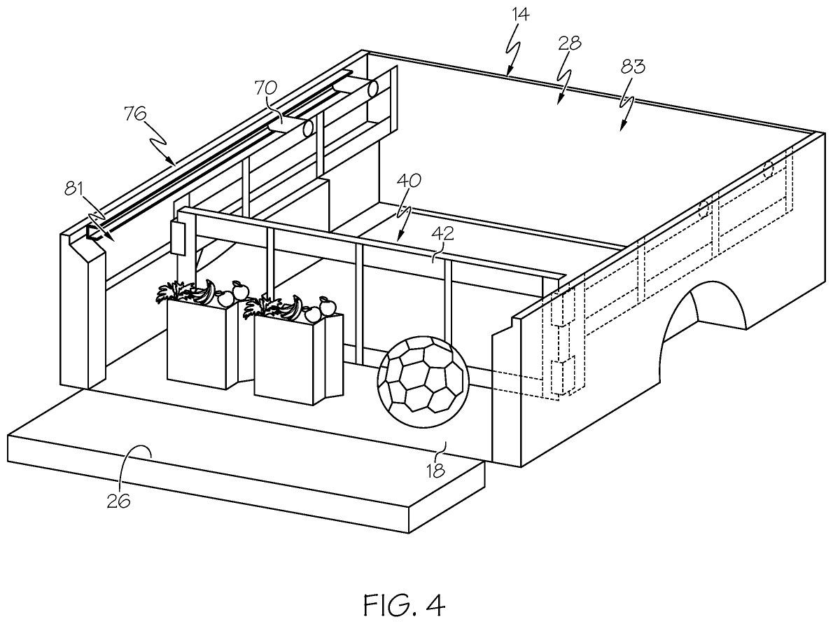

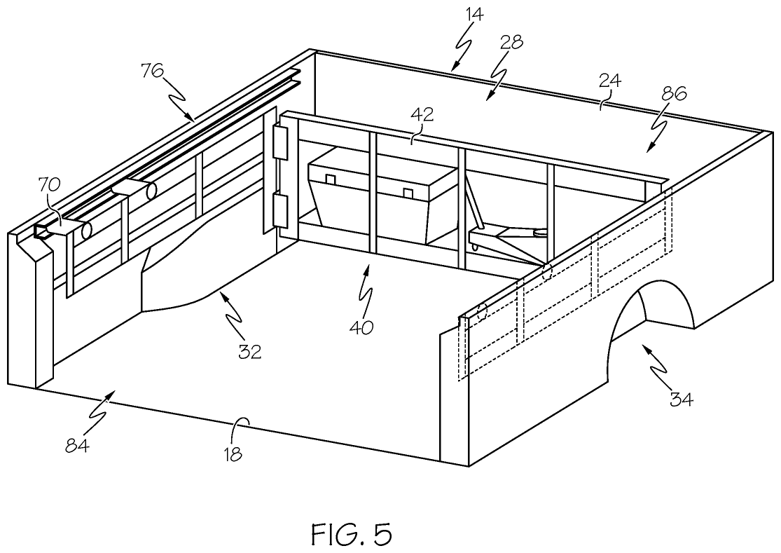

FIGS. 4 and 5 illustrate the truck bed extender 40 in different configurations from an extended truck bed configuration of FIG. 1 with the divider wall 42 positioned over tailgate 26. Referring first to FIG. 4, the truck bed extender 40 is illustrated in a first divider configuration with the divider wall 42 located over the bed deck 18 to divide the storage area 28 into a rearward, first storage portion 81 and a forward, second storage portion 83 that is larger than the first storage portion 81. Referring to FIG. 5, the truck bed extender 40 is illustrated in a second divider configuration with the divider wall 42 located over the bed deck 18 closer to the front wall 24 to divide the storage area 28 into a rearward, first storage portion 84 and a forward, second storage portion 86 that is smaller than the first storage portion 84. Moving between the configurations of FIGS. 1, 4 and 5 can be accomplished by loosening the connectors 70, sliding the connectors and rest of the truck bed extender 40 along the tie down rails 76 and 78 and then tightening the connectors 70 when in the desired position. To accomplish the position of FIG. 5, the truck bed extender 40 can be lifted and rotated to place the divider wall 42 in front of the wheel wells 32 and 34 as they may be sized to impede sliding movement of the divider wall 42 thereby.

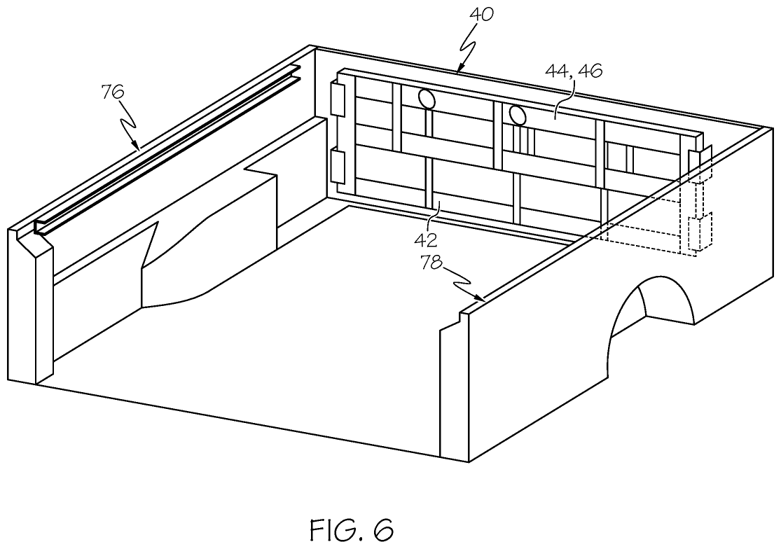

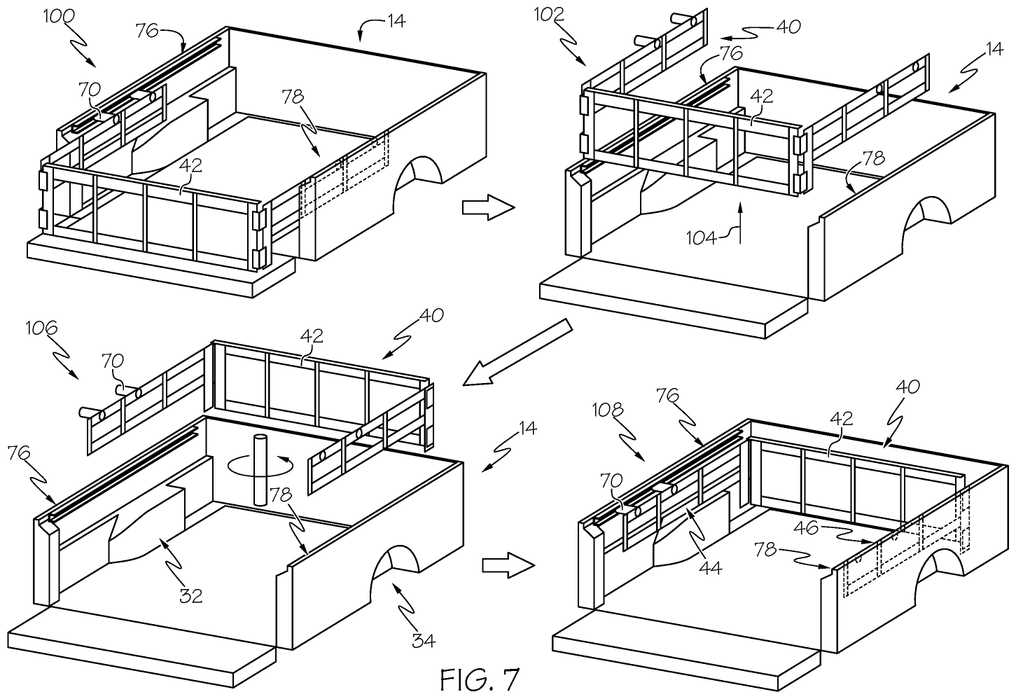

Referring to FIGS. 6 and 7, the truck bed extender 40 is illustrated being put into the stowed configuration, which is illustrated by FIG. 6. As represented in FIG. 7, in the truck bed extended configuration at step 100, the connectors 70 can be loosened so that they can be removed from the tie down rails 76 and 78 and then the truck bed extender 40 can be lifted, as represented by step 102 and arrow 104. At step 106, the truck bed extender 40 can be rotated to place the divider wall 42 in front of wheel wells 32 and 34. The truck bed extender 40 can then be lowered and the connectors 70 placed in the tie down rails 76 and 78 as discussed above and the connectors 70 then tightened as represented at step 108. Referring to FIG. 6, if the stowed configuration is desired, the connectors 70 may be removed from the tie down rails 76 and 78 and the side extenders 44 and 46 may be rotated against the divider wall 42 to reduce the footprint of the truck bed extender 40 within the truck bed 14.

The above-described truck bed extenders can be used to extend a length of a usable volume of the truck bed while inhibiting unintended movement of cargo out of the truck bed using the divider wall. The truck bed extenders can use tie down rails to allow for sliding movement of the truck bed extenders and also to lock the truck bed extenders into place within the truck bed. The truck bed extenders integrated with tie down rails can provide for multiple positions including a truck bed extended configuration with the divider wall over the tailgate, a rear storage position with the divider wall over the truck bed near the tailgate for easy access to cargo and a forward storage position with the divider wall over the truck bed for storage of cargo, such as tools. The truck bed extenders can also have a stowed configuration that is folded and placed against the front wall of the truck bed, out of the way of cargo space.

While particular embodiments have been illustrated and described herein, it should be understood that various other changes and modifications may be made without departing from the spirit and scope of the claimed subject matter. Moreover, although various aspects of the claimed subject matter have been described herein, such aspects need not be utilized in combination. It is therefore intended that the appended claims cover all such changes and modifications that are within the scope of the claimed subject matter.

What is claimed is:

1. A truck comprising:
a truck bed located rearward of a passenger cabin in a vehicle longitudinal direction, the truck bed includes a bed deck, a first sidewall and a second sidewall; and
a truck bed extender comprising a divider wall that extends in a vehicle lateral direction and side extenders on opposite sides of the divider wall that are configured to slidably connect to tie down rails within the truck bed, the side extenders pivotally connected to the divider wall so that the side extenders pivot against the divider wall in a stowed configuration.

2. The truck of claim 1 further comprising a first tie down rail extending longitudinally along the first sidewall and a second tie down rail extending longitudinally along the second sidewall.

3. The truck of claim 2, wherein the side extenders include a first side extender and a second side extender, wherein the first side extender includes a first connector that is configured to slide along the first tie down rail when connected thereto and the second side extender comprises a second connector that is configured to slide along the second tie down rail when connected thereto.

4. The truck of claim 3, wherein the first tie down rail comprises a first slot, the first connector comprising an anchor body that is sized to be received within the first slot.

5. The truck of claim 4, wherein the first connector comprises an anchor knob that is operatively connected to the anchor body such that turning the anchor knob tightens the anchor body against the first tie down rail at a desired location.

6. A truck bed extender for use in a bed of a truck, the truck bed extender comprising:
a divider wall that extends in a vehicle lateral direction and side extenders on opposite sides of the divider wall that are configured to slidably connect to tie down rails within a truck bed of the truck, the side extenders pivotally connected to the divider wall so that the side extenders pivot against the divider wall in a stowed configuration.

7. The truck bed extender of claim 6, wherein the side extenders include a first side extender and a second side extender, wherein the first side extender includes a first connector that is configured to slide along a first tie down rail when connected thereto and the second side extender comprises a second connector that is configured to slide along a second tie down rail when connected thereto.

8. The truck bed extender of claim 7, wherein the first tie down rail comprises a first slot, the first connector comprising an anchor body that is sized to be received within the first slot.

9. The truck bed extender of claim 8, wherein the first connector comprises an anchor knob that is operatively connected to the anchor body such that turning the anchor knob tightens the anchor body against the first tie down rail.

10. A method of stowing a truck bed extender within a truck bed of a truck, the method comprising:
detaching a connector of the truck bed extender from a tie down rail that extends along a sidewall of the truck bed, the truck bed extender comprising a divider wall that extends in a vehicle lateral direction and side extenders on opposite sides of the divider wall that are configured to slidably connect to tie down rails within the truck bed, the side extenders pivotally connected to the divider wall so that the side extenders pivot against the divider wall in a stowed configuration;
rotating the truck bed extender such that the divider wall is adjacent a front wall of the truck bed; and
rotating the side extenders relative to the divider wall such that the side extenders extend alongside the divider wall.

11. The method of claim 10 further comprising lifting the truck bed extender such that the divider wall is above wheel wells extending into the truck bed.

12. The method of claim 11 further comprising inserting the connector into a slot extending along the tie down rail.

13. The method of claim 12 further comprising locking the connector within the slot at a desired location along a length of the tie down rail.
